(19) United States
(12) Patent Application Publication
(10) Pub. No.: US 2008/0163499 A1
(43) Pub. Date: Jul. 10, 2008

(54) Pencil sharpener with replaceable decorative housing

(76) Inventor: Catalina M. Ojeda, San Antonio, TX (US)

Correspondence Address: Catalina M. Ojeda, 115 Gentry Street, San Antonio, TX, 78207, US

(21) Appl. No.: 11/649,874

(22) Filed: Jan. 5, 2007

(51) Int. Cl. B43L 23/00

(52) U.S. Cl. 30/453; 30/451

(57) ABSTRACT

Pencil sharpener with replaceable decorative housing with a standard pencil sharpener and a pencil sharpener housing. The housing comprised of two halves. The housing having retaining brackets within the halves that position the pencil sharpener accurately within the housing so that the pencil entrance portion of the pencil sharpener is aligned with an aperture in the housing. The housing halves held together in a way that allows easy separation without tools such as a magnetic closure. A preferred embodiment includes a housing platform that allows the housing to rest securely on a flat surface. A preferred embodiment includes a label holding portion so that the housing stand can be customized with an appropriate label such as “one sharp teacher”, or “one sharp baseball player” or other sayings that relate to the shape of each the pencil sharpener housing.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of sharpening devices and more specifically to a pencil sharpener with replaceable decorative housing.

Pencil sharpeners are well known. They are devices that refresh and sharpen the dulled point of a pencil. They include a shaving blade housed within a pencil receiving assembly. Most sharpeners also include a shavings holding portion that can be emptied as necessary. Pencil sharpeners can be either manual where the user twists the pencil or turns a crank of the sharpener, or electric, where the user inserts a pencil and the shaving mechanism turns by means of a motor and gear assembly thereby eliminating the need for the user to crank or twist.

Although pencil sharpeners are generally functional items whose housing simply reflect the function of holding the shaving mechanism and shaving receptacle, some pencil sharpeners have been designed where the housing of the sharpener takes the form of a recognizable decorative character. For example, U.S. Pat. No. 3,98,113 shows a sharpener that has an alligator head. Such unique housings create uniqueness and may cause a person to choose it over a traditional pencil sharpener.

However, although pencil sharpeners have been designed with decorative housings, no pencil sharpener to date has been designed so that the sharpener portion can be removed from the housing and replaced in another of a plurality of decorative housings. The design of a common sharpener that can be inserted into a variety of housings means that the sharpener can be customized for a specific end user, thereby making the sharpener appealing as a gift for a person with a specific professional skill or sports skill. For example, an apple shape may be suitable for a gift for a teacher, or a baseball shape may be suitable for an aspiring baseball player. The unique housing shape can be supported on a stand. The stand can include a place for a customized message such as “one sharp teacher” or “one sharp baseball player”. A common sharpener assembly means that a manufacturer can make one sharpener, and have it fit into a plurality of housings so that pencil sharpener sales can increase without having to tool a new sharpener assembly for each new housing.

### BRIEF SUMMARY OF THE INVENTION

The primary object of the invention is to provide a pencil sharpener that is housed within a decorative housing.

Another object of the invention is to provide a pencil sharpener that can be removed and replaced from a plurality of sharpener housings, each housing having common sharpener receiving holding brackets.

Another object of the invention is to provide a pencil sharpener and sharpener housing whose bottom shape may be rounded that can sit in a stationary position by being placed on a base platform.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed Pencil sharpener with replaceable decorative housing comprising: a standard pencil sharpener, a pencil sharpener housing, said housing comprised of two halves, said housing having retaining brackets within said halves that position said pencil sharpener accurately within said housing so that the pencil entrance portion of said pencil sharpener is aligned with an aperture in said housing, and said housing halves held together by a means that allows easy separation without tools such as a magnetic closure.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a perspective view of the sharpener housing in the upturned position.

FIG. 3 is a front view of one half of the invention.

FIG. 4 is an exploded view of the invention.

FIG. 5 is a perspective view of an alternate shape of a sharpener housing.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

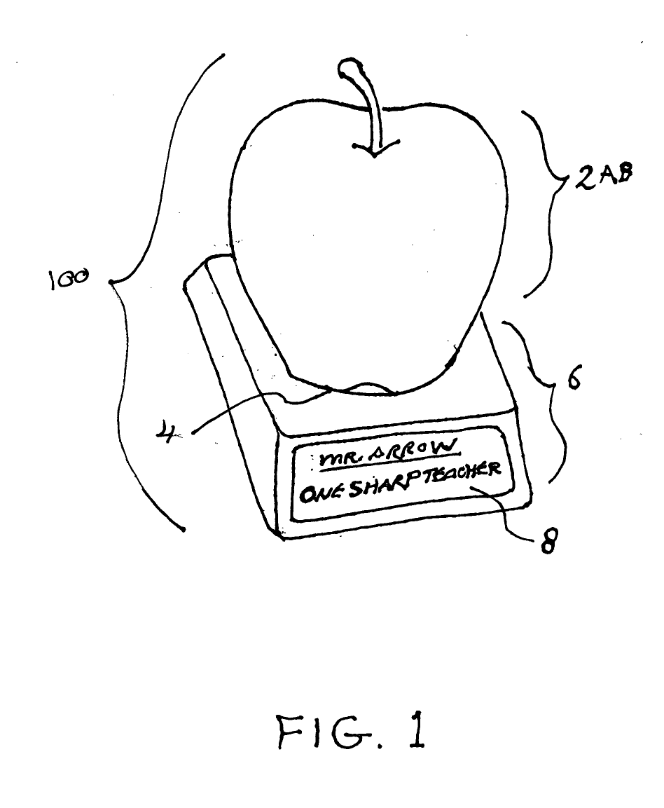

Referring now to FIG. 1 we see a perspective view of the invention 100. An apple shape comprised of two halves A and B rest on a stand 6 that has a concave shape 4 to hold the apple shape 2A,B removably in place. The stand 6 includes a front panel 8 that has words printed on it saying “one sharp teacher” and also including a place to print a teacher's name.

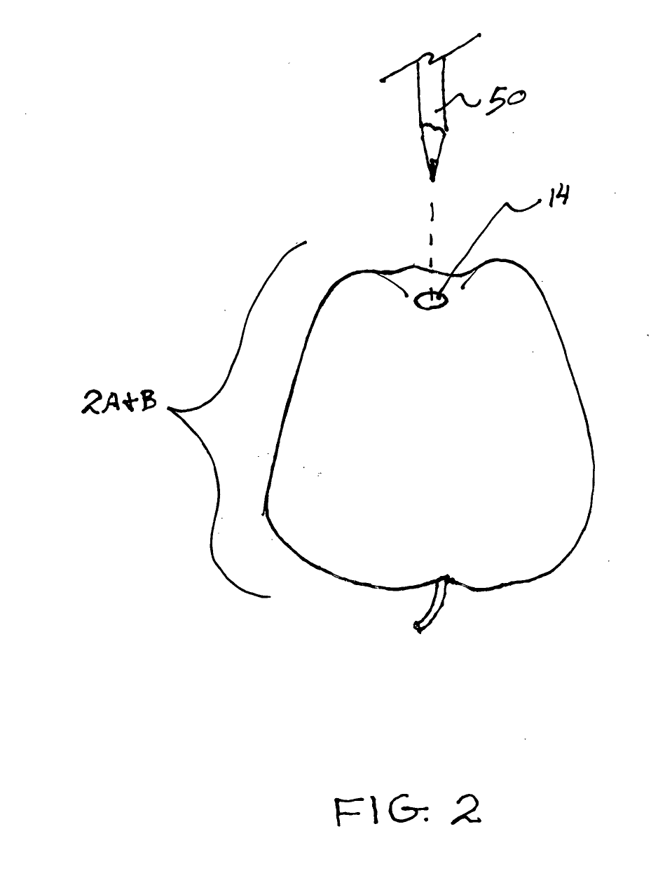

FIG. 2 shows a perspective view where the apple shape 2A,B is in the upside down position revealing an aperture 14 that can accept a standard pencil 50 for sharpening.

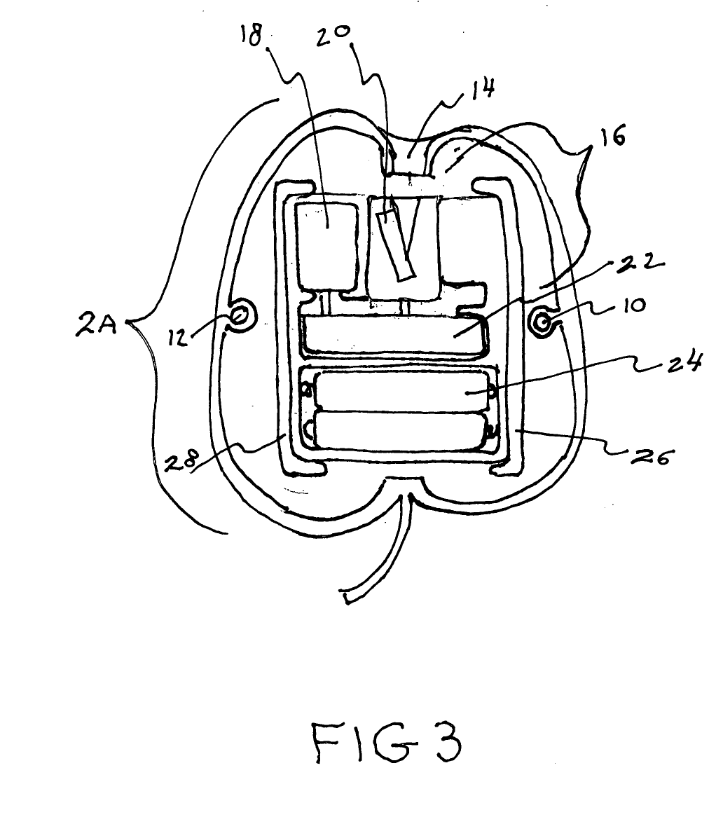

FIG. 3 shows a front view of apple half 2A and revealing an internal pencil sharpener assembly 16. In the present embodiment, the sharpener is electrically operated, however a standard manual type sharpener may also be used. In the preferred embodiment 16 shown, the sharpener mechanism 20 sits directly under aperture 14 and is driven by motor 18 and gear reduction assembly 22. The motor 18 is powered by batteries 24. Assembly 16 is removably held in place by holding brackets 26, 28. Apple half 2A is removably held to apple half B by magnets 10, 12 and corresponding ferrous plates located in apple half 2B. Other standard attachment means may also be used. Housing half 2B can also retaking pencil shavings that accrue from use. The housing halves 2A, 2B can be separated from each other to remove shavings as needed.

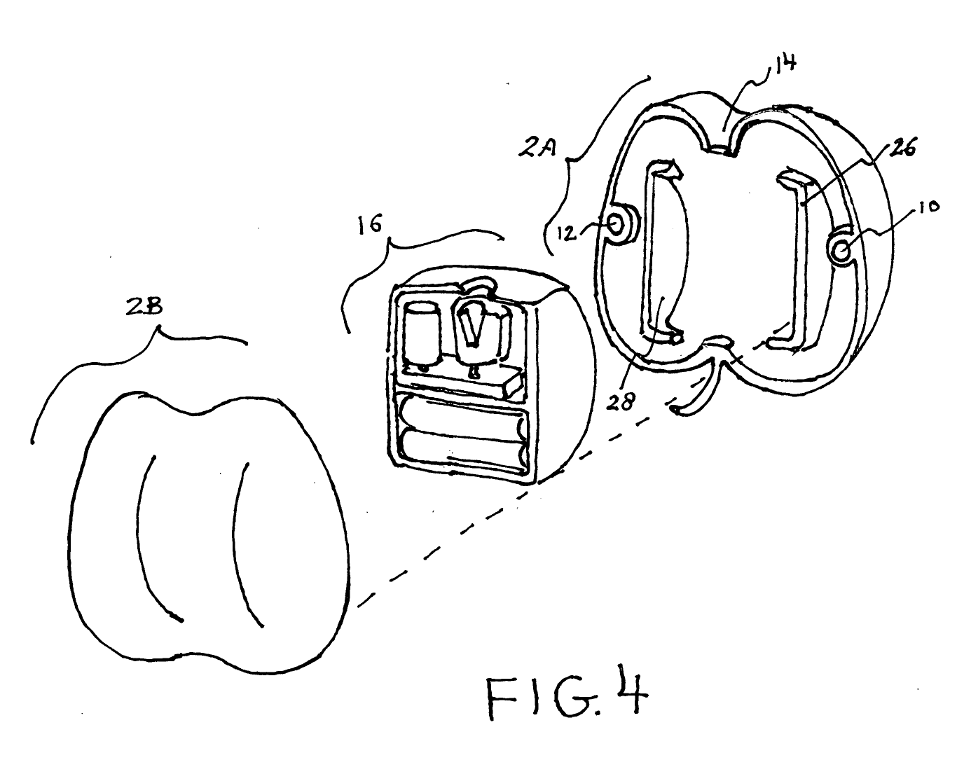

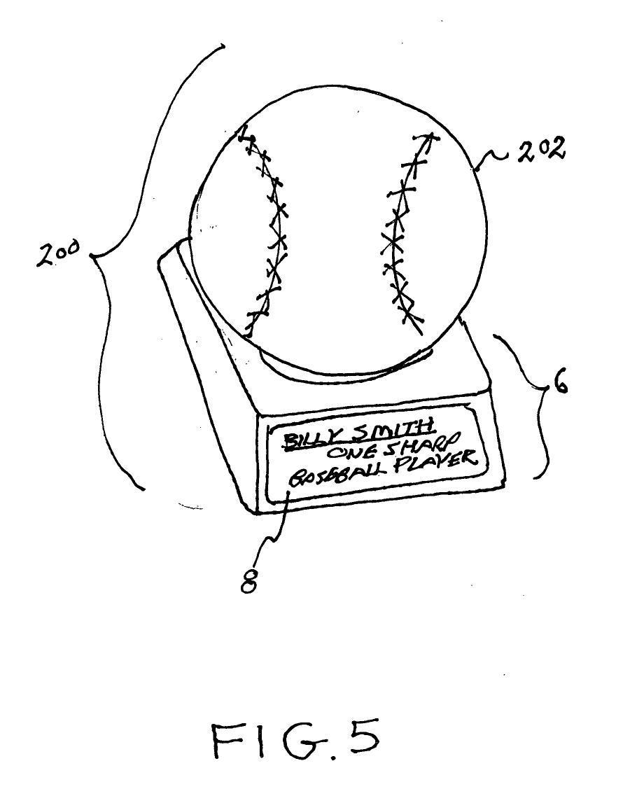

FIG. 4 shows an exploded view where pencil sharpening assembly 16 is removed from holding bracket 26, 28. The sharpening assembly 16 can be placed in other external shapes such as a baseball version of the invention 200 sown in FIG. 5. The front panel 8 of alternate shape 202 reads “one sharp baseball player”. Obviously other shapes, each having common sharpener holding brackets 26, 28, can be used to house the pencil sharpener assembly 16, such as a basket ball, a golf ball, or caricature relating to a profession such as the shape of a tooth for a dentist, or a scale of justice of a lawyer. In each case, the front panel can read “one sharp . . . ” as a play on words since the word sharp can pertain to a sharp pencil and also pertains to high intellectual capacity.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Pencil sharpener with replaceable decorative housing comprising:
a standard pencil sharpener;
a pencil sharpener housing;
said housing comprised of two halves;
said housing half having retaining brackets within said halves that position said pencil sharpener accurately within said housing so that the pencil entrance portion of said pencil sharpener is aligned with a pencil receiving aperture in said housing; and
said housing halves held together by standard means that allows separation without tools such as a magnetic closure.

2. Pencil sharpener with replaceable decorative housing as claimed in claim 1 further comprising a separate platform base having a concavity on its top surface that allows the rounded bottom of said sharpener housing to sit in a stationary manner when placed on a flat surface.

3. Pencil sharpener with replaceable decorative housing as claimed in claim 1 wherein said housing is shaped like an object that represents specific professional career or sports activity such as an apple, scale of justice, a tooth, a baseball or a golf ball.

4. Pencil sharpener with replaceable decorative housing as claimed in claim 2 wherein said base platform includes a label holding portion so that said invention can be customized with an appropriate label such as “one sharp teacher”, or “one sharp baseball player” or other sayings that relate to the shape of each corresponding said pencil sharpener housing.
